(19) United States
(12) Patent Application Publication
(10) Pub. No.: US 2026/0228995 A1
(43) Pub. Date: Aug. 6, 2026

(54) Text-Driven 3D Gaussian Splat Shape and Color Stylization

(71) Applicant: Niantic Spatial, Inc., San Francisco, CA (US)

(72) Inventors: Jamie Michael Wynn, London (GB); Zawar Imam Qureshi, London (GB); Jakub Powierza, London (GB); James Watson, London (GB); Mohamed Amr Abdelfattah Sayed, London (GB)

(21) Appl. No.: 19/465,859

(22) Filed: Jan. 30, 2026

Related U.S. Application Data
(60) Provisional application No. 63/753,361, filed on Feb. 3, 2025.

(51) Int. Cl. G06T 19/20; G06N 3/0475; G06T 3/18; G06T 5/50; G06T 5/70; G06T 7/70; G06T 15/08

(52) U.S. Cl. CPC G06T 19/20; G06N 3/0475; G06T 3/18; G06T 5/50; G06T 5/70; G06T 7/70; G06T 15/08; G06T 2207/20221; G06T 2219/2024

(57) ABSTRACT

A stylized three-dimensional (3D) model of a scene is generated and applied to stylize an image depicting the scene. The image, captured by a camera of a client device, is received and the pose of the camera at capture is determined. An unstylized 3D model of the scene is obtained and rendered to produce a set of unstylized images having poses along a representative trajectory. A diffusion model is applied to the set of unstylized images to generate a sequence of consistently stylized images, each stylization guided by earlier stylized frames. The stylized images are then used to generate a stylized 3D model. Based on the determined camera pose, the stylized 3D model is rendered to produce a stylized view of the scene, which is caused to be displayed by the client device.

### CROSS-REFERENCE TO RELATED APPLICATIONS

The present application claims the benefit of U.S. Provisional Application No. 63/753,361, filed on Feb. 3, 2025, which is incorporated by reference.

### BACKGROUND

### 1. Technical Field

The subject matter described relates generally to three-dimensional (3D) scene visualizations, and, in particular, to providing visualizations of scenes with 3D Gaussian splat models that are adjusted to include customized shape and color stylizations.

### 2. Problem

Augmented Reality (AR) applications enable a user to explore a physical space that has been supplemented with virtual objects. In conventional AR, the user views a camera feed depicting the physical environment with the virtual objects overlaid on the camera feed. However, there has recently been interest in using novel viewpoint synthesis to enable a user to have an AR-like experience that uses a photo-realistic (or at least close to photo realistic) model of a physical environment as the backdrop rather than a live camera feed. These approaches typically use novel viewpoint synthesis to generate views of the physical environment from viewpoints for which camera images are not available. However, conventional novel viewpoint synthesis techniques lack the ability to convincingly change geometry, which limits the ability to stylize and otherwise customize the user experience. This is because any geometry change requires increased style strength which is often capped for stylization stability and consistency. Thus, creating stylized representations of physical environment typically requires significant manual effort by designers and artists to generate a 3D model of the environment with the desired stylizations applied. Therefore, there is a need for approaches to modeling a physical environment that enable automated customized styling that is consistent across images and viewpoints.

### SUMMARY

The present disclosure describes various embodiments of a method for generating multi-view-consistent stylized 3D scene models from an unstylized 3D model of a scene (e.g., a 3D Gaussian stylized model may be generated from an unstylized 3D Gaussian splat model). A set of images (e.g., RGB images) and corresponding depth maps are rendered from the unstylized 3D model based on a smooth representative trajectory. A diffusion model, with independent controls for appearance and geometry stylization strength, sequentially stylizes each image using earlier stylized images as guidance. Consistency may be maintained through depth-guided cross-attention, feature injection, and a model conditioner trained to correct warping artifacts and fill missing regions. The resulting set of stylized images is used to generate a stylized 3D model, producing a stylized representation capable of rendering from various viewpoints while preserving an intended artistic style and the shapes and structure of a scene.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for providing stylized 3D representations of physical environments, according to one embodiment.

FIG. 4 depicts a pipeline that may be performed by the stylization generation module of FIG. 3, according to one embodiment.

FIG. 5 depicts a flowcharts of a process for applying a stylized 3D model and a process for generating a stylized 3D model, in accordance with some embodiments.

FIG. 6 illustrates an example computer system suitable for use in the networked computing environment of FIG. 3, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where stylized 3D representations of physical environments are desirable. In addition, the inherent flexibility of computer-based systems allows for a great variety of possible configurations, combinations, and divisions of tasks and functionality between and among the components of the system.

### Example Location-Based Parallel Reality Game

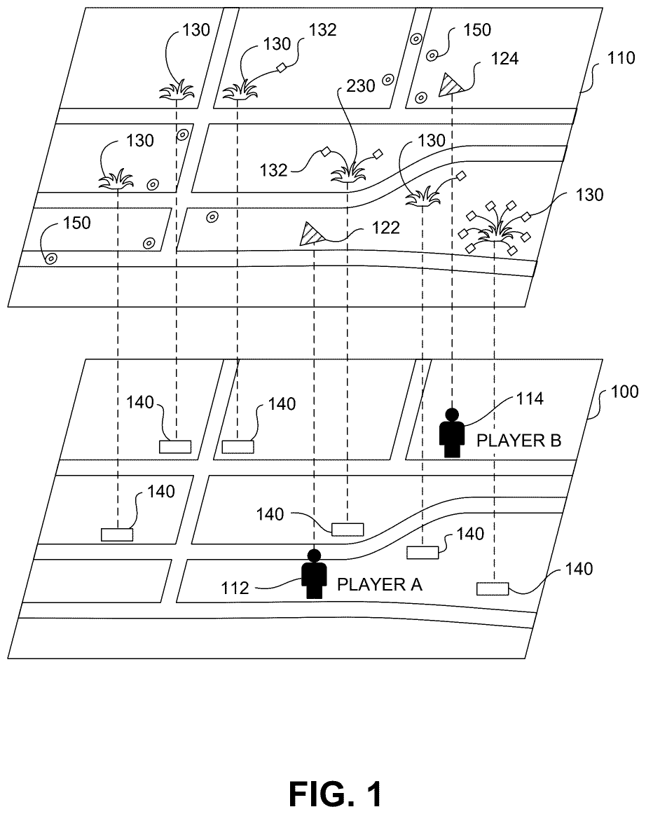

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

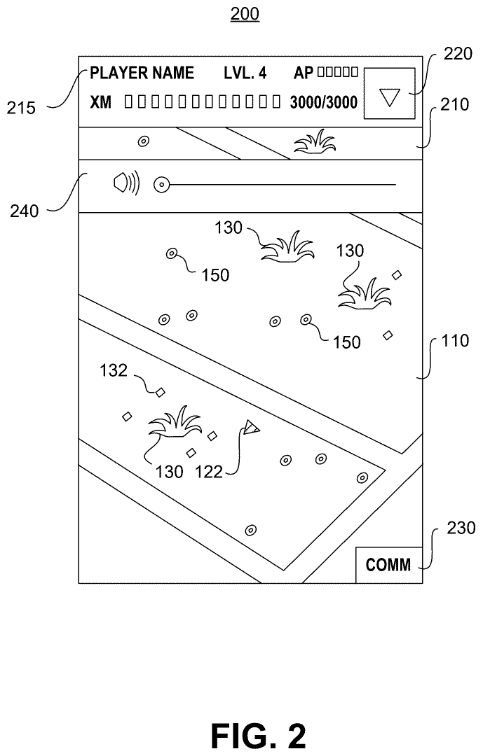

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

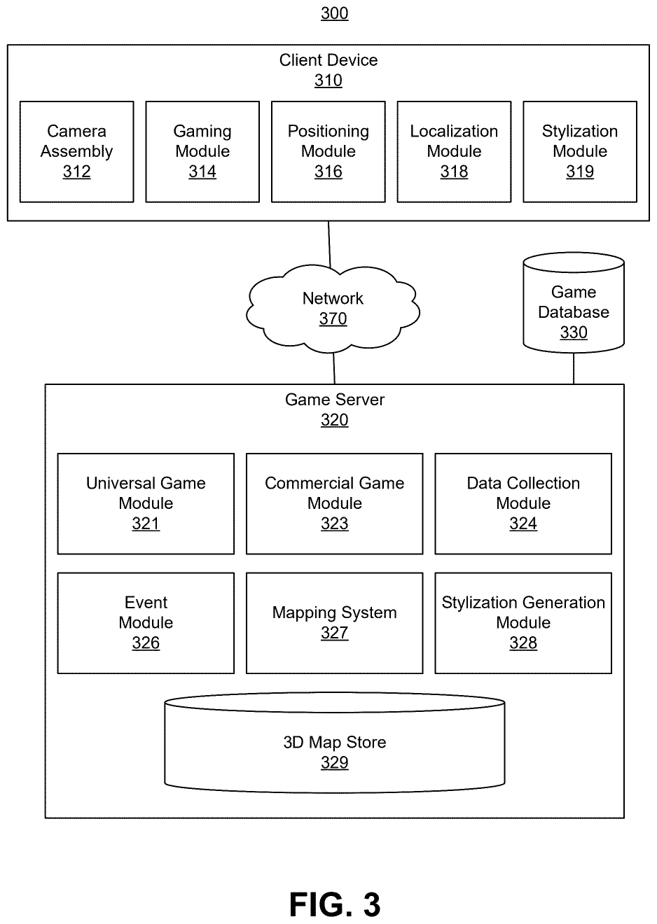

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, a localization module 318, and a stylization module 319. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video. The terms “image” and “frame” may be used interchangeably in the present description.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display), the real world itself (e.g., by displaying virtual elements on a transparent display of an AR headset), or a stylized 3D representation of the real world (e.g., as described below with reference to the stylization module 319) in a manner that gives the impression that the virtual objects are interacting with the real world. For example, a virtual character may hide behind a real tree, a virtual hat may be placed on a real statue, or a virtual creature may run and hide if a real person approaches it too quickly.

The stylization module 319 generates views of a physical environment that are stylized. In one embodiment, the stylization module 319 obtains a stylized 3D model of the physical environment (e.g., from the stylization generation module 328, as described below) which is used to generate stylized views of the physical environment (e.g., from the viewpoint/pose determined by the localization module 318). For example, the stylized 3D model may be a 3D Gaussian splat model that was generated based on images of the physical environment which is then used to render stylized views of the physical environment from the current pose of the client device 310.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 323, a data collection module 324, an event module 326, a mapping system 327, a stylization generation module 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 321 hosts an instance of the parallel reality game for a set of players (e.g., all players of the parallel reality game) and acts as the authoritative source for the current status of the parallel reality game for the set of players. As the host, the universal game module 321 generates game content for presentation to players (e.g., via their respective client devices 310). The universal game module 321 may access the game database 330 to retrieve or store game data when hosting the parallel reality game. The universal game module 321 may also receive game data from client devices 310 (e.g., depth information, player input, player position, player actions, landmark information, etc.) and incorporates the game data received into the overall parallel reality game for the entire set of players of the parallel reality game. The universal game module 321 can also manage the delivery of game data to the client device 310 over the network 370. In some embodiments, the universal game module 321 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 321. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 321. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The stylization generation module 328 may generate a stylized three-dimensional (3D) model of a physical environment (also referred to as a “scene”) to enable display of stylized views of the physical environment at a client device. The stylization generation module 328 may obtain or generate an unstylized 3D model (e.g., a Gaussian splat model) of the scene, which may be generated from images captured by one or more cameras (e.g., of a client device). The stylization generation module 328 may determine a representative trajectory of camera poses that may correspond to a likely movement path of a user through the scene. Based on that trajectory, the stylization generation module 328 may render a set of RGB images and corresponding depth maps depicting the scene using the unstylized 3D model. In some embodiments, the set of RGB images and corresponding depth maps depict the scene from camera poses in the representative trajectory. The stylization generation module 328 may further receive an instruction or prompt describing how the scene is to be stylized, along with one or more style strength parameters that may include separate values for controlling appearance stylization (e.g., color) strength and geometry stylization (e.g., depth) strength.

In some embodiments, the stylization generation module 328 renders a set of unstylized images in a particular sequence, where each pair of consecutive images may represent camera poses with small incremental changes in position and orientation. The set of unstylized images may be referred to as unstylized RGB and depth (RGBD) images. This ordering may be selected to minimize discontinuities between adjacent frames, which may support multi-view consistency in subsequent stylization. In particular, multi-view consistency allows a user to view the stylized images as though the stylized images belong to the same 3D scene, even when the scene is viewed from different angles. Multi-view consistency allows style changes (e.g., textures, colors, or shapes) to stay aligned across images. For example, multi-view consistency may prevent an object depicted in the stylized images from suddenly changing its look when the camera pose changes marginally (e.g., the camera moves so that its viewing direction changes by less than 10 degrees relative to the object). In some embodiments, the particular sequence in which the unstylized images are rendered may be determined based on a uniformly spaced sampling of poses along a predefined, representative trajectory.

The representative trajectory may be defined as a smooth, continuous path through the 3D Gaussian splat model, constructed by connecting together a series of camera poses where each pose corresponds to a viewpoint along that path. Rendering may produce RGBD images for each pose or viewpoint, where a given RGBD image includes two separate but aligned outputs rendered from each pose: an RGB image showing what a camera would see from that pose and a depth map indicating for each pixel how far that point in the scene is from the camera. The RGBD images may be stored for processing.

The stylization generation module 328 may apply a diffusion model to each image in a sequence of unstylized images. In some embodiments, the diffusion model may be applied in an autoregressive manner; the application to a given image may be guided by one or more earlier images that have already been stylized, enabling consistent propagation of stylistic and geometric modifications. The stylization generation module 328 may use composite inputs that combine the current unstylized image with warped imagery from reference stylized images (i.e., previously stylized images). This sequential stylization may occur for each image along the trajectory until the entire set has been processed. By basing each new stylization on a prior image's stylization, the stylization generation module 328 may maintain consistency between views and enable coherent retraining of a stylized 3D model. For example, when a sequence of images has been stylized in a consistent way across different viewpoints, the stylized images may be used as training data to build or refine a stylized 3D model that preserves the applied style without introducing visual artifacts or mismatches between angles.

Before applying a diffusion model to a given unstylized image, the stylization generation module 328 may prepare an input comprising the unstylized image (e.g., an RGB image rendered from the unstylized 3D model), a depth map of the image, a prompt for stylizing the image, and style strength parameters. Alternatively, the image and depth map may be combined (e.g., as an RGBD image). The style strength parameters may include a first strength value controlling the degree of color stylization, and a second strength value controlling the extent of geometry (e.g., depth or shape) modification. The diffusion model may process both RGB and depth channels at once, but the noise level applied to each channel may be controlled independently based on the respective strength value. Input preparation may also include normalizing depth data and formatting RGBD inputs for compatibility with the network architecture. This formatting may include resizing images to a required resolution, normalizing RGB and depth values, or arranging the data into channel and tensor formats expected by a diffusion model. By controlling the noise levels for the RGB channels and depth channel separately, the stylization generation module 328 may adjust the style of colors or shapes independently, while still ensuring that the final image remains visually consistent between its colors and its geometric structure.

The stylization generation module 328 may denoise the RGB channels and depth channels simultaneously, but with independent noise schedules. Each channel may have a respective maximum timestep at which noise is introduced, such that stylization strength in color and geometry may be independently modulated. During inference, once a channel reaches its maximum timestep value, updates for that channel may be discarded while processing of the other channel continues until its limit is reached. The independent control of noise schedules may provide versatility for different styling needs, such as preserving geometry while modifying textures, or vice versa. This mechanism may also support fine-tuning to avoid over-alteration of either modality.

In some embodiments, the stylization generation module 328 implements depth-guided alignment, using depth data from two or more images to determine which regions in the images correspond to the same physical locations in 3D space. This alignment produces a geometric correspondence map (a depth-guided mapping) that indicates, for each pixel in a target (unstylized) image, the pixel or pixels in a reference (previously stylized) image that represent the same underlying scene point. The stylization generation module 328 may use depth-guided alignment to perform depth-guided cross attention, feature injection, or both.

Depth-guided cross-attention may refer to one way of utilizing depth-guided alignment within the attention layers of a diffusion model. A geometric correspondence map may be used to weight or mask the attention between a target image's features and a reference image's features, so that geometrically matching reference features influence the stylization of the target image. In some embodiments, depth-guided cross-attention may result in only the geometrically matching reference features influencing the stylization of a target image. Cross-attention may use alignment information indirectly, by adjusting how much the model “looks at” reference features during processing.

In some embodiments, the stylization generation module 328 may implement depth-guided alignment to identify geometric correspondences between an unstylized image and one or more previously stylized reference images. The stylization generation module 328 may use an unstylized 3D model of a scene to determine which pixels of a target image and a reference image represent the same physical scene points. In some embodiments, the stylization generation module 328 may use depth maps of both a target image a reference image, along with their camera poses, to project pixels into a common three-dimensional coordinate space and determine which pixels represent the same physical scene points. The process for determining which pixels represent the same scene points may result in a geometric correspondence map that links each pixel in the current image to the pixel(s) in the reference image that share its 3D location. The correspondence map may then be used to control how information is transferred from the reference image to the target image.

Feature injection may refer to another mechanism for using depth-guided alignment, in which features from a reference image are copied (or blended) into a target image's intermediate representations at locations identified as corresponding by the depth-guided alignment. Unlike cross-attention, feature injection may transfer data directly, rather than adjusting attention weights.

In some embodiments, the stylization generation module 328 may implement feature injection based on reference images to improve multi-view consistency. The stylization generation module 328 may determine a mapping between pixels of a current unstylized image and pixels of a previously stylized image using their respective depth maps. From this mapping, the stylization generation module 328 may identify reference features in the earlier stylized image that geometrically align with target features in the current image. Selected reference features may be directly injected into the activations of certain layers in a diffusion model, which may influence the stylization outcome for the current image. This injection may occur where strong geometric correspondence is found, reducing the risk of misplacing stylistic details and avoiding texture artifacts.

The stylization generation module 328 may generate a warped reference image by projecting a previously stylized image, using its corresponding depth map, into the viewpoint of the current unstylized image. The warped reference image may be composited with the current unstylized image to produce color and depth composites. These composites may be used to train a model conditioner (e.g., a ControlNet), which may learn to correct warping artifacts and fill in missing regions. During stylization, the trained model conditioner may guide a diffusion model to follow the composites while producing consistent outputs. Use of the model conditioner may enable accurate propagation of stylistic features between images without introducing distortions.

The stylization generation module 328 may compute a validity mask for each warped reference image, marking which pixels should be trusted for compositing. Trustworthiness may be determined based on occlusion comparisons, alignment between the surface normal at a pixel and the viewing direction, and the position of the reference image in the sequence. Pixels deemed invalid may be excluded from the composite or down-weighted during conditioning to prevent the diffusion model from replicating artifacts. The validity mask may be provided to the model conditioner along with the composites, enabling improved correction and inpainting. Incorporating validity masks may help ensure that high-quality warped data informs the stylization process.

In some embodiments, before applying a diffusion model to an unstylized image, the stylization generation module 328 may perform a partial denoising diffusion implicit model (DDIM) inversion. The partial inversion may include adding a predefined amount of noise (e.g., to remove high-frequency artifacts from the RGBD input), then inverting to reach a controlled noise level. For a given pair of RGB and depth channels, a respective noise limit may be set for each channel (e.g., a noise limit for the color channel and another noise limit for the depth channel). When a respective noise limit is reached, updates for the channel may be stopped while the other channel continues to be processed. This channel-specific stopping mechanism may enable precise control over how far stylization extends in either appearance or geometry. Partial DDIM inversion with independent update discarding may improve output quality while preserving desired scene details.

In some embodiments, some or all of the operations performed by the stylization generation module 328 may be performed at a client device (e.g., the client device 310). In one example, the client device 310 may receive an unstylized 3D model of a scene and generate a stylized 3D model using the unstylized 3D model. In another example, the game server 320 may receive an unstylized 3D model from the client device, generate a set of consistently styled images from unstylized images rendered using the unstylized 3D model, and provide the set of consistently styled images for the client device to generate the stylized 3D model.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Example Stylization Pipeline

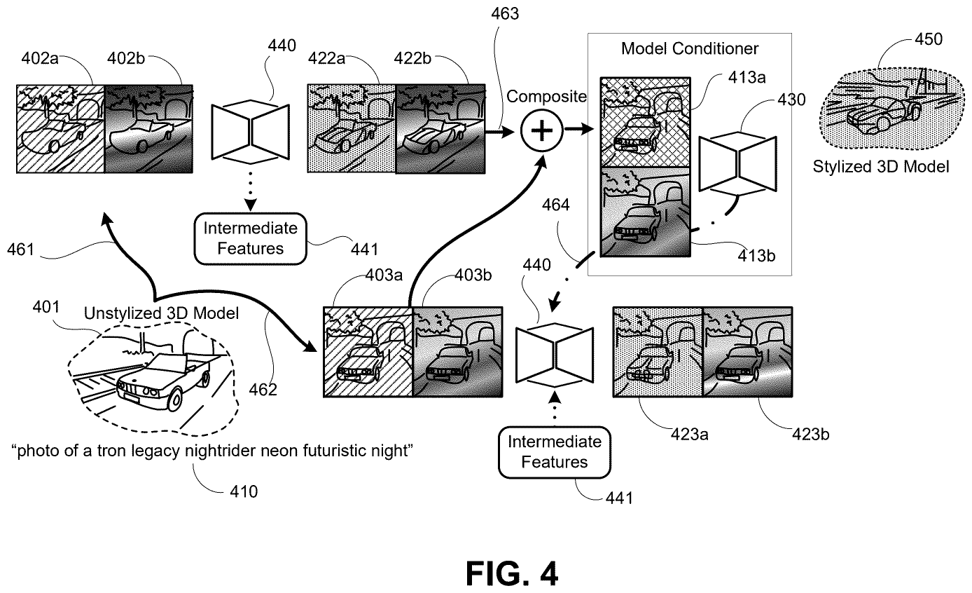

FIG. 4 depicts a pipeline 400 that may be performed by the stylization generation module 328, in accordance with one embodiment. The stylization generation module 328 may perform the pipeline 400 to create a stylized 3D model 450 from an unstylized 3D model 401 of a scene. In some embodiments, the pipeline 400 may take place after earlier operations, such as capturing an image or video of the scene using a client device (e.g., a mobile phone) and determining the pose of the camera at the time of capture. Although not depicted, the pipeline 400 may also be followed by later operations, such as causing display of a stylized view of the scene on a client device using the stylized 3D model 450. The pipeline 400 may combine rendering operations, stylization stages using a diffusion model, warping and compositing of reference images, conditioning using a model conditioner, and feature sharing. The depicted embodiment shows how these coordinated steps may generate a sequence of stylized RGBD images suitable for transforming the unstylized 3D model 401 into a coherent, style-specific representation.

The stylization generation module 328 may begin by performing a rendering action 461 on the unstylized 3D model 401. As part of this operation, the module may determine a representative trajectory (e.g., a smooth, ordered sequence of camera poses through the scene) so that the set of rendered images can be processed in a sequence that minimizes abrupt changes in viewpoint between consecutive images. The rendering action 461 may produce, for one pose in this trajectory, an RGB render 402a of the scene and a corresponding depth map 402b. The terms “viewpoint” and “pose” may be used interchangeably unless suggested otherwise by the context in which the term is used. The RGB render 402a and the depth map 402b may be combined into an RGBD image 402 representing both the appearance and geometry of the scene from that camera pose. The RGBD image 402 may be stored as a candidate for stylization. The RGBD image 402 may serve as input to a diffusion model 440. Additionally, the stylization generation module 328 may supply a prompt 410 specifying the desired visual style to the diffusion model for processing the RGBD image 402. In this case, the prompt 410 specifies a request for a “photo of a tron legacy nightrider neon futuristic night.”

The diffusion model 440 may process the RGBD image 402 with the prompt 410 and one or more style strength parameters to generate a stylized RGB render 422a and a stylized depth map 422b. In one example, a style strength parameter is a parameter for controlling an amount by which color in the RGBD image is stylized. In a second example, a style strength parameter is a parameter for controlling an amount by which depth or geometry is stylize. The RGB render 422a and the depth map 422b may be combined into a stylized RGBD image 422. In subsequent stages of the pipeline 400, the RGBD image 422 may be treated as a previously stylized image suitable for guiding the stylization of later images. The stylization generation module 328 may retain the stylized image 422 for reference or for use in warping operations. This forms the basis of an autoregressive process in which prior stylizations support the generation of consistent future views.

The stylization generation module 328 may then perform a second rendering action 462 on the unstylized 3D model 401 for a different camera pose. This rendering may produce an RGB render 403a and a depth map 403b, which may be combined into an RGBD image 403. The RGBD image 403 is initially unstylized and is positioned in the sequence for stylization with guidance from earlier stylized images, such as the RGBD image 422. Because the pipeline 400 aims for multi-view consistency, the pose for RGBD image 403 may be selected so that its viewpoint has a degree of variation from a viewpoint of the earlier rendered pose of the RGBD image 402 that is less than a predetermined threshold to prevent extreme changes in pose between one image and the next. The small change in viewpoint may facilitate coherent propagation of stylistic details across images.

In some embodiments, the stylization generation module 328 may perform a warping action 463, in which the previously stylized RGBD image 422 is warped based on its depth map 422b to align with the camera pose of the unstylized RGBD image 403. The warped version of the RGBD image 422 may then be composited with RGBD image 403 to create a warped reference image 413. The warped reference image 413 may include a composite RGB render 413a and a composite depth map 413b. This compositing enables visual and geometric information from the stylized reference image to be combined with the unstylized current image in preparation for conditioning.

The warped reference image 413 may then be supplied to a model conditioner 430. In one embodiment, the model conditioner 430 may be implemented as a ControlNet. The model conditioner 430 may be trained to process RGB and depth composites. The model conditioner 430 may be trained to guide the stylization process by correcting artifacts in warped regions of the composite and inpainting missing areas in a manner consistent with both appearance (e.g., color) and geometry (e.g., shape or depth). Conditioning may take into account the prompt 410 as well trustworthiness information, such as a validity mask generated elsewhere in the pipeline. By preparing conditioning data in this way, the diffusion model 440 may be influenced to produce stylizations that respect both geometric alignment and the intended style.

In some embodiments, the stylization generation module 328 may perform a conditioning action 464, where the outputs of the model conditioner 430 influence the diffusion model 440 while the diffusion model 440 processes the unstylized RGBD image 403. The stylization generation module 328 may also share intermediate features 441 between the unstylized RGBD image 403 and one or more reference images (e.g., the stylized RGBD image 422) to strengthen stylistic and geometric consistency. This guided process produces a stylized RGB render 423a and a stylized depth map 423b, which are combined into a stylized RGBD image 423. The RGBD image 423 may then be added to the set of stylized images available for guiding future images in the sequence.

The intermediate features 441 may refer to representations generated within the layers of the diffusion model that capture higher-level information about both the stylized and unstylized inputs during processing. The intermediate features 441 can encode semantic details such as object boundaries, surface textures, and geometric relationships that have been established in earlier images. By storing and reusing an intermediate features from a previously stylized image, the stylization generation module 328 may guide the current image's stylization toward maintaining consistent colors, textures, and geometry across multiple views. This reuse helps carry forward fine-grained stylistic cues without re-deriving them from scratch, reducing the risk of inconsistencies or “drift” between images.

In some embodiments, depth-guided alignment may determine which intermediate features are relevant for feature injection. This may allow features corresponding to matching 3D locations in the scene to influence the current image's output. Depth-guided alignment may involve using depth maps of both the current image and a previously stylized reference image to compute pixel-to-pixel correspondences in 3D space. By projecting the depth information into a shared coordinate system, the stylization generation module 328 may identify which pixels in the reference image represent the same physical points in the scene as pixels in the current image. This spatial matching helps prevent transferring features from unrelated regions, reducing the likelihood of misplaced textures or geometry artifacts.

The stylization generation module 328 may repeat the process for each image along the representative trajectory until a full set of stylized RGBD images is produced. Once the sequence is complete, the stylization generation module 328 may produce the stylized 3D model 450. For example, the stylization generation module 328 may retrain the original unstylized 3D model 401 using a set of stylized RGBD images. Retraining may embed the stylistic transformations directly into the geometry and texture data of the 3D model 401, producing the stylized 3D model 450. The stylized model 450 may preserve style elements consistently over viewpoints captured by the representative trajectory. As a result, the model can be rendered from arbitrary camera poses while retaining the intended stylization.

Although FIG. 4 depicts warping and conditioning with a model conditioner, in alternative embodiments other architectures may be employed for conditioning operations. For example, the conditioning may be performed without explicit warping by using depth-guided cross-attention between images, which may be used on its own or in combination with warping operations. Depth-guided cross-attention may also be combined with feature injection to transfer aligned stylization features from reference images into the diffusion model's activations. In some embodiments, the rendering actions 461 and 462 may be replaced with other novel-view synthesis rendering techniques, such as mesh-based rendering or volumetric rendering. The diffusion model 440 may be implemented in different forms and may process sequences of images in varying orders to optimize consistency or computational efficiency.

Technical advantages of the pipeline 400 may include the ability to maintain multi-view consistency by combining warping, compositing, and conditioning steps with depth-informed feature sharing. The stylization generation module 328 may allow independent control over geometry and appearance stylization via distinct processing of RGB and depth channels while still producing coherent outputs. The use of warped reference images and model conditioning may reduce visual artifacts and propagate stylistic features accurately between images.

### Example Embodiments of Compositing Details

In some embodiments, composite images may be formed for each reference frame by converting the RGBD frame into a mesh, rendering the mesh from the viewpoint of a target frame to be stylized, and compositing the rendered reference and target frames together. For each pixel in the valid region of the warp, a determination may be made whether to use the warped reference frame's pixel values or the corresponding pixel values from the unstylized target frame. In one example, this determination may be made by computing a compositing score S_{i,j} for each pixel according to:

$${S}_{i , j} = {λ}_{1} \vert sin ( {θ}_{i , j} ) \vert - {λ}_{2} \frac{{d}_{i , j}^{′}}{{d}_{i , j}} + {λ}_{3} ( i d x - i d {x}^{′} )$$

where θ_{i,j} represents the angle between the mesh normal at target-frame pixel (i, j) and the camera look-at vector of the reference frame (even while compositing in the target frame),

$${d}_{i , j}^{′}$$

is the depth at pixel (i, j) in the warped stylized reference frame, and d_{i,j} is the depth at the same pixel in the unstylized target frame. The variables idx and idx′ denote the indices of the target and reference frames, respectively, within the camera trajectory. The first term rewards geometry that is viewed face-on in the reference frame, reducing susceptibility to warping artifacts. The second term is an occlusion term favoring whichever frame's geometry occludes the other at that pixel. The final term tends to favor older reference frames, as earlier frames are generally less likely to contain artifacts from repeated warping. Because of the autoregressive nature of the pipeline, (idx−idx′) may be positive.

In some embodiments, the constants λ₁, λ₂, and λ₃ are weighting parameters controlling the contribution of each factor to the composite score. In one embodiment, they may be set to λ₁=1.0, λ₂=3.0, and λ₃=0.02. These parameter values may allow the compositing process to balance geometric orientation, occlusion relationships, and frame age in determining whether to use warped reference data or the unstylized target frame data for any given pixel. This scoring process may enable final composites to prioritize geometrically accurate, visually reliable pixel information for conditioning stylization of subsequent frames.

### Example Embodiments of Cross Attention Implementation

In some embodiments, depth-guided attention may be implemented using heatmaps L_{i,j} that encode whether a token i from a reference image forward-warps to the location of token j in a target image. To construct these heatmaps, the reference RGBD image may be converted into a mesh and rendered into the target frame to determine a mapping of reference-frame pixel coordinates (u, v) to target-frame pixel coordinates (u′, v′) under the forward warp. This mapping may be represented as a flow field F∈

[symbol]

$${F}_{u , v} = ( {u}^{′} , {v}^{′} )$$

where:

The flow field can then be expanded into a 4D tensor A_{u,v,u′v′}, defined as:

$${A}_{u , v , {u}^{′} , {v}^{′}} = δ ( round ( {F}_{u , v}^{T} ) - ( {u}^{′} , {v}^{′} ) )$$

This tensor A_{u,v,u′y′} may take the value 1 when the reference-frame coordinates map exactly to the target-frame coordinates under the forward warp, and 0 otherwise. In some embodiments, this tensor is blurred along the spatial axes of the reference frame so that each target-frame feature may also attend to features in its immediate vicinity in the reference image. The blurring may be accomplished via convolution with a kernel K:

$${L}_{u , v , {u}^{′} , {v}^{′}} = {A}_{u , v , {u}^{′} , {v}^{′}} * K$$

where * represents convolution along the u and v axes. The blur kernel K may be defined as:

$$K ( Δ u , Δ v ) = max ( 1 - \frac{{‖ Δ u , Δ v ‖}_{2}}{{d}_{max}} , 0 )$$

In one embodiment, dₘₐₓ is set to 100 pixels.

The resulting heatmap L encodes the correspondence strength between reference and target pixels, reflecting the desire that a target-frame pixel should attend to the reference-frame pixels that forward-warp to it. To achieve some nonzero level of attention to all reference-frame features, L may be clipped as:

$${L}_{u , v , {u}^{′} , {v}^{′}} ← max ( {L}_{u , v , {u}^{′} , {v}^{′}} , {L}_{min} )$$

where the hyperparameter Lₘᵢₙ controls the locality of the cross-attention. For example, Lₘᵢₙ=0.5 may be used for forward-facing scenes and Lₘᵢₙ=0.3 for other scenes.

Because attention layers inside the diffusion U-Net may operate at downscaled resolutions, the heatmaps L_{i,j} may be downscaled before usage. This may be accomplished by reshaping the 4D tensor L_{u,v,u′v′} to be indexed by pixel coordinates in both the reference and target frames, max-pooling across the u, v dimensions, then separately max-pooling across the u′, v′ dimensions, and finally reshaping back into a 2D tensor

$${L}_{i , j}^{′}$$

or appropriate size for the attention layer's feature maps.

Modifying the cross-attention in this way may allow each attention layer in the RGBD diffusion model's U-Net to concatenate keys (and values) from both the target-frame features and the reference-frame features, with the mask entries from L_{i,j} modulating the attention strength based on geometric alignment.

In some embodiments, the U-Net's cross-attention layers may be modified so that the keys and values are formed by concatenating the target-frame keys with all reference-frame keys, for however many reference frames are available. A heatmap L_{i,j} constructed as described above may be incorporated into the attention mask A in a cross-attention of the diffusion model, where the cross-attention is represented by:

$$softmax ( \frac{{Q [ {K}_{self} , {K}_{r e f} ]}^{T}}{\sqrt{{d}_{k}}} + log Δ ) V$$

This may allow the attention strength between a target feature and a reference feature to be modulated according to geometric correspondence derived from depth. All self-attention layers of the RGBD diffusion model U-Net may be modified in this way, while a model conditioner (e.g., a ControlNet) remains unchanged.

Feature injection may be performed as a direct means of transferring features between reference and target images after each depth-conditioned cross-attention operation. A mixing matrix M may be computed as:

$${M}_{i , j} = {softmax}_{i} ( \frac{{L}_{i , j}}{T} )$$

with a low temperature T=0.001, effectively producing an argmax so that reference features that warp directly to a given target feature are considered, reducing blur. A weight for injection into a given target hidden state j may be defined as:

$${w}_{j} = {max}_{i} {L}_{i , j} {λ}_{i n j e c t}$$

where λ_{inject} is a hyperparameter, set to 0.15 for forward-facing scenes and 0.2 for others. This weight suppresses injection if no reference features align to the target feature. The updated target-frame hidden state

$${h}_{j}^{′}$$

may then be computed as:

$${h}_{j}^{′} = ( 1 - {w}_{j} ) {h}_{j} + {w}_{j} {\sum }_{i} {h}_{ref , i} {M}_{i , j}$$

This operation blends the target hidden states with appropriately aligned reference hidden states, weighted so that only reliable geometric correspondences influence the target frame's stylization.

### Example Embodiments of a Diffusion Model

A diffusion model for stylizing images as described herein may be configured to stylize both RGB images and depth maps. In some embodiments, depth may be represented as disparity rather than absolute distance. One rationale for this may be that disparity offers higher fidelity closer to the camera.

To enable independent control over geometry stylization and appearance stylization, the system may introduce time parameters T_{RGB_max} and T_{D_max} that separately define the extent of noise applied to the RGB and depth channels. These parameters are set relative to the maximum training timestep, with values ranging from zero (no noise added) to one (full Gaussian noise).

Two additional binary mask channels may be provided to the U-Net input: one for RGB and one for depth. Each mask indicates whether updates to the respective modality will be retained or discarded at the current timestep. For example, the RGB mask may have a value of 0 if T_{RGB_max}<t and 1 otherwise, meaning updates to RGB should be ignored at this point; similarly, the depth mask may be set to 0 if T_{D_max}<t and 1 otherwise.

Training may proceed by:
1. Randomly selecting T_{RGB_max} and T_{D_max} (e.g., half of the time selecting them independently, half of the time setting them equal).
2. Applying noise to the RGB channels up to T_{RGB_max} and noise to the depth channels up to T_{D_max}
3. Generating the binary masks as described above.
4. Passing the RGB image, depth map, prompt, style parameters, and the masks into the U-Net during training, allowing the model to condition its generation on which updates will be discarded.
5. Running the U-Net denoising process and computing the loss based on the produced outputs.

This training procedure allows the diffusion model to maintain consistency between RGB and depth outputs, while enabling precise independent adjustment of stylization strength for color and geometry.

In one embodiment, training may be performed for 30,000 steps with a batch size of 4 and accumulation over 8 batches (effective batch size of 32). An exponential learning rate scheduler may be used, starting at 3×10⁻⁵ with a warmup of 100 steps, decaying to 3×10⁻⁷ by step 25,000.

During inference, updates to RGB channels may be discarded whenever T_{RGB_max}<t, and updates to depth channels discarded when T_{D_max}<t. This may provide fine-grained control over how much color and how much geometry is altered in the stylization output.

### Example Embodiments of Model Conditioner Training

Synthetic data pairs may be generated for training the model conditioner by starting with a dataset of RGBD pairs of unstylized and stylized frames produced using the diffusion model. The stylized RGBD image may be forward-warped to an arbitrary camera view and then warped back to the original identity camera to form a warped RGBD image (RGBD_{warped}). Composites may then be created for conditioning using the validity mask generated from the second forward-warp.

When compositing depth information, RGBD_{warped} depths may be scaled to match the target depth map. In some embodiments, scaling may prioritize areas with contextual overlap between the unstylized depth map and the RGBD_{warped} depths to reduce the influence of outliers such as large flat regions. To achieve this, values near the edges of invalid regions may be emphasized during scaling.

Stylization prompts for the RGBD training pairs may be obtained from a prompt generation model. Example prompts include:
1. “Ethereal, mystical landscape with glowing, luminescent plants.”
2. “A futuristic cyberpunk cityscape at dusk.”
3. “Victorian-era style illustration of a fantastical steampunk airship soaring above the clouds.”

The model conditioner may be trained for 180,000 steps, with a batch size of 6 and gradient accumulation over 2 batches to yield an effective batch size of 12. A constant learning rate of 1×10⁻⁴ may be used throughout training.

### Example Embodiments of DDIM Inversion

When stylizing a new frame, the game server 320 may begin by inverting that frame to noise using a DDIM inversion process. This approach can yield more consistent results because, unlike simply adding Gaussian noise, it does not destroy the information content of the original RGBD image. During inversion, the game server 320 may condition on a prompt describing the content of the unstylized scene (an “inversion prompt”), although in some cases an empty prompt may be used without significantly impacting output quality.

The DDIM inversion procedure may be based on the approximation that the steps predicted by the diffusion model at consecutive timesteps are similar, expressed as:

$$ϵ ( {x}_{t + 1} ) \approx ϵ ( {x}_{t} )$$

This allows inversion to be performed by repeatedly obtaining a step from the diffusion model and then stepping in the opposite direction to reach progressively higher noise levels.

Because depth models are used during training, the diffusion model may be sensitive to high-frequency characteristics of the RGBD frame. In cases where splat artifacts are present, this sensitivity can lead to visual artifacts. To improve robustness, a partial inversion step may be used in which noise is first added to the input RGBD image (a partial noise unstylized image) to reach a noise level Tₙₒᵢₛₑ, after which the inversion process continues for the remaining steps. This initial noise addition helps destroy high-frequency components that could cause artifacts, while preserving lower-frequency signals. In some embodiments, Tₙₒᵢₛₑ may be set to 0.05 to balance artifact reduction with preservation of depth map information.

For cases where T_{RGB_max}≠T_{D_max}, the inversion process may be adapted. T_{RGB_max} may represent a noise limit for a color channel while T_{D_max} may represent a noise limit for a depth channel. If T_{RGB_max}>T_{D_max}, inversion proceeds normally until T_{D_max} is reached, after which updates to depth channels are discarded while RGB channels continue. Conversely, if T_{RGB_max}<T_{D_max}, updates to the RGB channels may be discarded after reaching T_{RGB_max} while continuing inversion for the depth channels. This relatively non-destructive inversion method may also help preserve view-dependent effects (e.g., reflections) from the original input frame.

### Example Stylization Process

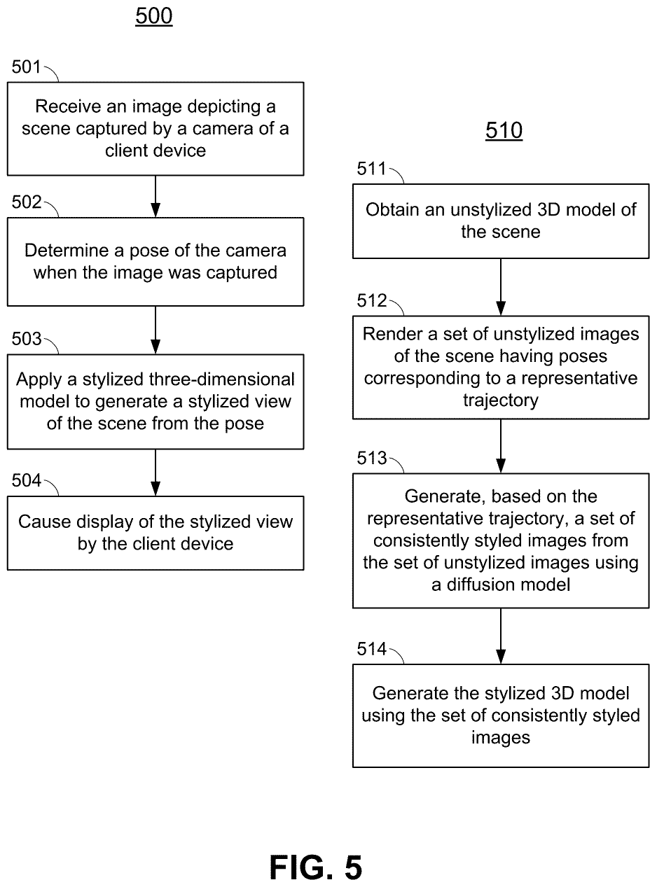

FIG. 5 depicts a flowcharts of a process 500 for applying a stylized 3D model and a process 510 for generating a stylized 3D model, in accordance with some embodiments. The steps of FIG. 5 are illustrated from the perspective of the game server 320 (e.g., the stylization generation module 328) performing the process 500 and the process 510. However, some or all of the steps may be performed by other entities or components. In some embodiments, the game server 320 may perform one of the processes 500 or 510, while the other one of the processes 500 or 510 is performed by a separate computing system (e.g., the client device 310). In addition, some embodiments may perform the steps in parallel, perform the steps in different orders, or perform different steps.

Referring to the process 500 for applying a stylized 3D model, the game server 320 may receive 501 an image depicting a scene captured by a camera of a client device. This image can originate from various sources, such as a still photo or an individual frame extracted from a video. In one example, the game server 320 receives a frame from a video depicting a realistic painting of a horse, captured by the camera of a user's mobile phone while the user pans across the painting. The received frame serves as the starting visual data for subsequent pose determination and application of a stylized 3D model.

The game server 320 may determine 502 a pose of the camera when the image was captured. Determining the camera pose may include computing the position and orientation of the camera relative to the scene depicted in the image. This determination can employ image-based localization techniques or directly use metadata available from the client device, such as inertial sensor data and lens parameters. Following the previous example, the game server 320 determines from the video frame's metadata that the camera was positioned two meters in front of the painting and angled slightly downward, enabling accurate alignment of the eventual stylized view with the original captured perspective.

The game server 320 may apply 503 a stylized 3D model to generate a stylized view of the scene from the pose. This step may involve selecting or generating a stylized 3D model whose geometry and appearance reflect the style specified by the user, then rendering the stylized 3D model from the determined pose so that the viewpoint matches the camera's original perspective. The stylized three-dimensional model may be generated by the process 510. Following the previous example, the game server 320 uses a stylized 3D model of the horse painting created according to a “cubist portrait of a horse” prompt, and renders the 3D model from the same angle and distance as the captured video frame, producing a view in which the horse's form within the painting is segmented into geometric shapes and abstract textures while retaining scene alignment.

The game server 320 may cause 504 display of the stylized view by the client device. Causing display may include transmitting the rendered stylized view back to the client device for presentation in real-time or storing it for later retrieval. Following the previous example, the game server 320 sends the cubist-styled render of the horse painting to the user's mobile phone, where it is displayed as an augmented reality overlay that replaces the realistic painting in the live video feed with the cubist version.

Turning now to the process 510 for generating a stylized 3D model, the game server 320 may obtain 511 an unstylized 3D model of the scene. Obtaining this model may involve generating it from captured imagery using novel-view synthesis methods, retrieving a pre-existing model from a database, or reconstructing it from multiple photographs. Obtaining the model may include generating a Gaussian splat from one or more training images of the scene or reconstructing a 3D representation from multiple photographs or video frames (e.g., using a neural radiance field, or NeRF). Following the previous example, the server builds an unstylized 3D Gaussian splat model of the horse painting using frames extracted from the user's provided video.

The game server 320 may render 512, using the unstylized three-dimensional model of the scene, a set of unstylized images of the scene having poses corresponding to a representative trajectory. Rendering the set of unstylized images of the scene may include rendering RGB images and corresponding depth maps (collectively RGBD images) at poses corresponding to the representative trajectory. Following the previous example, the server 320 renders RGB images and depth maps of the horse painting from slightly varied angles along an arc, simulating a viewer moving past the artwork.

The game server 320 may generate 513, based on the representative trajectory, a set of consistently styled images from the set of unstylized images using a diffusion model. Generating may include applying the diffusion model to each of the set of unstylized images to produce the consistently styled images according to the sequence, with applications following an initial application to the first image in the sequence of unstylized images, based on an earlier stylized image in the sequence. This approach may preserve multi-view consistency. Following the previous example, the server 320 sequentially stylizes each rendered view of the horse painting into a cubist composition in the trajectory of the viewer moving past the artwork.

The game server 320 may generate 514 the stylized three-dimensional model using the set of consistently styled images. The resulting stylized model may be characterized by the artistic style (e.g., geometry, texture, color, etc.) of the consistently styled images. The stylized three-dimensional model may be used to render the scene from arbitrary viewpoints while retaining stylistic changes and geometric structure. Following the previous example, the game server 320 uses the cubist-styled images of the horse painting to generate a stylized model that may create cubist renderings of the painting from a position along or beyond the representative trajectory.

The game server 320 may apply the diffusion model by receiving as input for an unstylized image its RGB render, its rendered depth map, an image modification prompt, and style strength parameters. The style strength parameters may include a first parameter for controlling how much the depth is stylized and a second parameter for controlling how much the color is stylized. Applying the diffusion model can include denoising both a color channel and a depth channel, and modifying the noise schedule for each channel using separate maximum timesteps to control stylization strength for each. Following the previous example, the server 320 applies higher color stylization to emphasize cubist color planes while minimizing depth alterations to keep the structure of the horse painting consistent.

The game server 320 may determine, using respective depth maps of an unstylized image and a previously stylized image, a depth-guided mapping between pixels of the two images, identify a reference feature from the previously stylized image aligned to a target feature in the unstylized image, and inject the reference feature into the diffusion model so that the stylization of the unstylized image is influenced by the reference feature. Following the previous example, the server 320 transfers cubist block patterns from a previously stylized horse-painting image in a sequence of unstylized images into matching regions of the current view according to their 3D scene alignment.

The game server 320 may generate a warped reference image based on a depth map of a previously stylized image in the sequence, generate a composite image of the warped reference image and an unstylized image in the sequence (the composite having a color composite and a depth composite) train a model conditioner using the color and depth composites, and condition the diffusion model using the model conditioner. Following the previous example, the server uses a warped cubist-horse image generated from a previously stylized image of the horse painting as a guide to help the diffusion model fill in and stylize corresponding regions of the current unstylized frame of the horse painting.

The game server 320 may determine a validity mask based on trustworthiness of pixels of the previously stylized image, generate the model conditioner further using the validity mask, and set trustworthiness according to factors such as occlusions, the angle between a surface normal at a pixel and the viewing direction, or the relative order of the image in the sequence. Following the previous example, the game server 320 creates a warped version of a previously stylized view of the horse painting aligned to the current camera pose. Pixels on the horse's face that are clearly visible and directly facing the camera in the original stylized view are marked valid, while pixels along the edge of the canvas that were partially occluded in the reference viewpoint (or at steep surface angles) are marked invalid so they will not introduce distortions into the stylization of the current frame.

The game server 320 may, for each of the set of unstylized images of the scene, add a predefined amount of noise into the image to generate a partial-noise unstylized image and apply a DDIM configured to introduce noise at steps. Applying the DDIM may include, after reaching a noise limit for a depth channel, stopping noise introduction to that channel, and after reaching a noise limit for a color channel, stopping noise introduction to that channel. Following the previous example, using a partial-noise unstylized image and applying a DDIM may enable the server 320 to change the cubist-style colors while preserving depth geometry for the horse-painting scene.

### Example Computing System

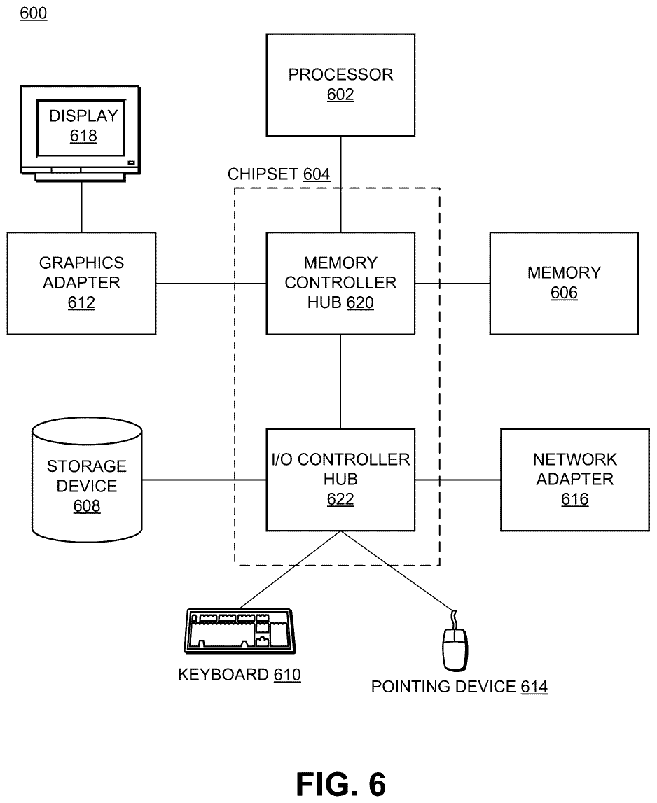

FIG. 6 is a block diagram of an example computer 600 suitable for use as a client device 310 or game server 320. The example computer 600 includes at least one processor 602 coupled to a chipset 604. References to a processor (or any other component of the computer 600) should be understood to refer to any one such component or combination of such components working cooperatively to provide the described functionality. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 370.

The types of computers used by the entities of FIG. 3 can vary depending upon the embodiment and the processing power required by the entity. For example, the game server 320 might include multiple blade servers working together to provide the functionality described. Furthermore, the computers can lack some of the components described above, such as keyboards 610, graphics adapters 612, and displays 618.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by any claims that ultimately issue.

What is claimed is:

1. A computer-implemented method comprising:
receiving an image depicting a scene captured by a camera of a client device;
determining a pose of the camera when the image was captured;
applying a stylized three-dimensional (3D) model to generate a stylized view of the scene from the pose, wherein the stylized 3D model was generated by:
obtaining an unstylized 3D model of the scene;
rendering, using the unstylized 3D model of the scene, a set of unstylized images of the scene having poses corresponding to a representative trajectory;
generating, based on the representative trajectory, a set of consistently styled images from the set of unstylized images using a diffusion model; and
generating the stylized 3D model using the set of consistently styled images; and
causing display of the stylized view by the client device.

2. The computer-implemented method of claim 1, wherein generating the set of consistently styled images comprises:
applying the diffusion model to each of the set of unstylized images to generate the set of consistently stylized images according to a sequence, wherein an application of the diffusion model to an unstylized image in the set of unstylized images is based on an earlier stylized image in the sequence.

3. The computer-implemented method of claim 1, wherein generating the set of consistently styled images comprises:
generating a first stylized image by applying the diffusion model to a first unstylized image that has a first pose according to the representative trajectory;
generating a warped stylized image by warping the first stylized image to a second pose, the second pose being of a second unstylized image according to the representative trajectory; and
generating a second stylized image by applying the diffusion model to the second unstylized image and the warped stylized image.

4. The computer-implemented method of claim 3, wherein applying the diffusion model to each of the set of unstylized images comprises:
receiving as input, for the unstylized image, an image render of the unstylized image, a rendered depth map of the unstylized image, an image modification prompt, and style strength parameters, where the style strength parameters include at least one of a first strength parameter for controlling an amount by which color in the unstylized image is stylized or a second strength parameter for controlling an amount by which depth in the unstylized image is stylized; and
applying the diffusion model to the received input.

5. The computer-implemented method of claim 3, wherein applying the diffusion model to each of the set of unstylized images comprises:
denoising a color channel and a depth channel of the unstylized image; and
modifying a noise schedule for each of the color channel and the depth channel using respective maximum color and depth timesteps, the maximum color timestep controlling a strength of stylization applied to the color channel, the maximum depth timestep controlling a strength of stylization applied to the depth channel.

6. The computer-implemented method of claim 3, further comprising:
determining, using respective depth maps of the unstylized image and a previously stylized image, a depth-guided mapping between pixels of the unstylized image and pixels of the previously stylized image;
identifying, based on the depth-guided mapping, a reference feature associated with the previously stylized image aligned to a target feature in the unstylized image; and
injecting the reference feature into the diffusion model such that the application of the diffusion model to the unstylized image is influenced by the reference feature.

7. The computer-implemented method of claim 1, wherein the set of unstylized images of the scene are ordered in a sequence, further comprising:
generating a warped reference image based on a depth map of a previously stylized image in the sequence, the previously stylized image being stylized by the diffusion model;
generating a composite image of the warped reference image and an unstylized image in the sequence, the composite image having a color composite and a depth composite;
training a model conditioner using the color composite and the depth composite; and
conditioning the diffusion model using the model conditioner.

8. The computer-implemented method of claim 7, further comprising:
determining a validity mask based on trustworthiness of pixels of the previously stylized image, wherein the model conditioner is trained further using the validity mask, and wherein the trustworthiness is associated with at least one of a presence of occlusion depicted in the scene, an angle between a surface normal at a given pixel of the previously stylized image and a viewing direction of the camera in the previously stylized image, or an order of the previously stylized image in the sequence.

9. The computer-implemented method of claim 1, further comprising:
for each of the set of unstylized images of the scene:
adding a predefined amount of noise into the unstylized image to generate a partial noise unstylized image; and
applying a denoising diffusion implicit model (DDIM) configured to introduce noise into the partial noise unstylized image at steps.

10. The computer-implemented method of claim 9, wherein applying the DDIM comprises:
in response to determining that the noise introduced into the partial noise unstylized image has reached a noise limit for a depth channel of the partial noise unstylized image, stopping noise introduction into the depth channel; and
in response to determining that the noise introduced into the partial noise unstylized image has reached a noise limit for a color channel of the partial noise unstylized image, stopping noise introduction into the color channel.

11. The computer-implemented method of claim 1, wherein obtaining the unstylized 3D model of the scene comprises generating a Gaussian splat from one or more training images of the scene.

12. A non-transitory computer-readable medium comprising instructions, the instructions, when executed by a computer system, causing the computer system to perform operations including:
receiving an image depicting a scene captured by a camera of a client device;
determining a pose of the camera when the image was captured;
applying a stylized three-dimensional (3D) model to generate a stylized view of the scene from the pose, wherein the stylized 3D model was generated by:
obtaining an unstylized 3D model of the scene;
rendering, using the unstylized 3D model of the scene, a set of unstylized images of the scene having poses corresponding to a representative trajectory;
generating, based on the representative trajectory, a set of consistently styled images from the set of unstylized images using a diffusion model; and
generating the stylized 3D model using the set of consistently styled images; and
causing display of the stylized view by the client device.

13. The non-transitory computer-readable medium of claim 12, wherein generating the set of consistently styled images comprises:
applying the diffusion model to each of the set of unstylized images to generate the set of consistently stylized images according to a sequence, wherein an application of the diffusion model to an unstylized image in the set of unstylized images is based on an earlier stylized image in the sequence.

14. The non-transitory computer-readable medium of claim 12, wherein generating the set of consistently styled images comprises:
generating a first stylized image by applying the diffusion model to a first unstylized image that has a first pose according to the representative trajectory;
generating a warped stylized image by warping the first stylized image to a second pose, the second pose being of a second unstylized image according to the representative trajectory; and
generating a second stylized image by applying the diffusion model to the second unstylized image and the warped stylized image.

15. The non-transitory computer-readable medium of claim 14, wherein applying the diffusion model to each of the set of unstylized images comprises:
receiving as input, for the unstylized image, an image render of the unstylized image, a rendered depth map of the unstylized image, an image modification prompt, and style strength parameters, where the style strength parameters include at least one of a first strength parameter for controlling an amount by which color in the unstylized image is stylized or a second strength parameter for controlling an amount by which depth in the unstylized image is stylized; and
applying the diffusion model to the received input.

16. The non-transitory computer-readable medium of claim 14, wherein applying the diffusion model to each of the set of unstylized images comprises:
denoising a color channel and a depth channel of the unstylized image; and
modifying a noise schedule for each of the color channel and the depth channel using respective maximum color and depth timesteps, the maximum color timestep controlling a strength of stylization applied to the color channel, the maximum depth timestep controlling a strength of stylization applied to the depth channel.

17. The non-transitory computer-readable medium of claim 14, wherein the operations further include:
determining, using respective depth maps of the unstylized image and a previously stylized image, a depth-guided mapping between pixels of the unstylized image and pixels of the previously stylized image;
identifying, based on the depth-guided mapping, a reference feature associated with the previously stylized image aligned to a target feature in the unstylized image; and
injecting the reference feature into the diffusion model such that the application of the diffusion model to the unstylized image is influenced by the reference feature.

18. The non-transitory computer-readable medium of claim 12, wherein the set of unstylized images of the scene are ordered in a sequence, and the operations further include:
generating a warped reference image based on a depth map of a previously stylized image in the sequence, the previously stylized image being stylized by the diffusion model;
generating a composite image of the warped reference image and an unstylized image in the sequence, the composite image having a color composite and a depth composite;
determining a validity mask based on trustworthiness of pixels of the previously stylized image, the trustworthiness being associated with at least one of a presence of occlusion depicted in the scene, an angle between a surface normal at a given pixel of the previously stylized image and a viewing direction of the camera in the previously stylized image, or an order of the previously stylized image in the sequence;
training a model conditioner using the color composite, the depth composite, and the validity mask; and
conditioning the diffusion model using the model conditioner.

19. The non-transitory computer-readable medium of claim 12, wherein the operations further include:
for each of the set of unstylized images of the scene:
adding a predefined amount of noise into the unstylized image to generate a partial noise unstylized image; and
applying a denoising diffusion implicit model (DDIM) configured to introduce noise into the partial noise unstylized image at steps, applying the DDIM comprising:
in response to determining that the noise introduced into the partial noise unstylized image has reached a noise limit for a depth channel of the partial noise unstylized image, stopping noise introduction into the depth channel; and
in response to determining that the noise introduced into the partial noise unstylized image has reached a noise limit for a color channel of the partial noise unstylized image, stopping noise introduction into the color channel.

20. A computer-implemented method comprising:
receiving an image depicting a scene captured by a camera of a client device;
determining a pose of the camera when the image was captured;
applying a stylized three-dimensional (3D) model to generate a stylized view of the scene from the pose, wherein the stylized 3D model is configured by parameters including a first strength parameter for controlling an amount by which color in the image is stylized and a second strength parameter for controlling an amount by which depth in the image is stylized; and
causing display of the stylized view by the client device.

21. The computer-implemented method of claim 20, wherein the stylized 3D model was generated by a process comprising:
obtaining an unstylized 3D model of the scene;
rendering, using the unstylized 3D model of the scene, a set of unstylized images of the scene having poses corresponding to a representative trajectory;
generating, based on the representative trajectory, a set of consistently styled images from the set of unstylized images using a diffusion model, wherein generating each consistently styled image comprises:
denoising a color channel and a depth channel of the unstylized image; and
modifying a noise schedule for each of the color channel and the depth channel using respective maximum color and depth timesteps, the maximum color timestep selected based on the first strength parameter and the maximum depth timestep selected based on the second strength parameter; and
generating the stylized 3D model using the set of consistently styled images.
